(19) United States
(12) Patent Application Publication
(10) Pub. No.: US 2012/0104021 A1
(43) Pub. Date: May 3, 2012

(54) BEVERAGE SYSTEM ARCHITECTURES FOR REFRIGERATORS

(75) Inventors: NIHAT CUR, SAINT JOSEPH, MI (US); TIEMEN VAN DILLEN, VARESE (IT); GREGORY G. HORTIN, HENDERSON, KY (US)

(73) Assignee: WHIRLPOOL CORPORATION, BENTON HARBOR, MI (US)

(21) Appl. No.: 12/915,095

(22) Filed: Oct. 29, 2010

(51) Int. Cl. B67D 7/00; B01F 3/04; A23L 2/00; F25B 29/00

(52) U.S. Cl. 222/1; 165/61; 99/323.1; 99/323.3

(57) ABSTRACT

A refrigerator with a liquid conditioning system providing a variety of levels and types of conditioned liquid streams for outputting to a refrigerator dispenser is disclosed. A liquid conditioning circuit having means for outputting ambient, cold, heated, filtered, and carbonated liquid streams for use in combination with a refrigerator is also disclosed. A finished beverage made from a conditioned liquid stream or combination of conditioned liquid streams is enhanced with one or more liquid enhancements components provided by a liquid enhancement system.

### FIELD OF THE INVENTION

The present invention relates to a beverage dispensing architecture for a refrigerator, and more particularly, to a refrigerator having one or more liquid conditioning systems or circuits for providing various conditioned liquid streams to a liquid dispenser for dispensing or preparing beverages.

### BACKGROUND OF THE INVENTION

Dispensing liquid from an indoor dispenser of a refrigerator is well known. In fact, many new and existing refrigerators have an indoor dispenser having a liquid outlet to dispense liquid from the refrigerator. Although these existing refrigerators can dispense a conditioned liquid stream, such as chilled water, no concept or platform exists for a refrigerator configured to dispense a number of conditioned liquid streams, such as a heated liquid stream, a chilled liquid stream, a carbonated liquid stream, a filtered liquid stream, an ambient temperature liquid stream, an irradiated liquid stream, an oxygenated liquid stream and/or other conditioned liquid streams. Because current refrigerators lack these capabilities, they are incapable of dispensing a broad gamut of conditioned liquid streams from a single dispenser. The inability to provide a diverse and extensive selection of conditioned liquid streams also limits the types of beverages that can ultimately be prepared. Therefore, a need has been identified in the art to provide a refrigerator with a liquid dispensing system outputting various types and levels of conditioned liquid streams, whether for drinking or preparing other beverages or foods.

A further need has also been identified in the art to provide liquid conditioning circuits for conditioning liquid to be dispensed or reservoired using integrated or dedicated liquid conditioning modules, operating independently or dependently from each other.

A still further need has been identified in the art to provide a combination of liquid conditioning modules that interface with a modulated or integrated liquid enhancement system for preparing and outputting an array of beverages at a refrigerator dispenser.

### BRIEF SUMMARY OF THE INVENTION

It is a primary object, feature or advantage of the present invention to improve over the state of the art.

It is a further object, feature or advantage of the present invention to provide a refrigerator equipped with a liquid dispensing system or circuit outputting to the dispenser of the refrigerator varying levels and types of conditioned liquid streams.

Yet another object, feature or advantage of the present invention is to provide a liquid conditioning circuit outputting varying levels and types of conditioned liquid streams.

A further object, feature or advantage of the present invention is to provide a liquid conditioning system or circuit reconfigurable or modifiable by removing, adding or exchanging modulated conditioning components in the system or circuit.

Still another object, feature or advantage of the present invention is to provide a liquid conditioning system or circuit for use in combination with a liquid enhancement system for preparing a finished beverage comprising a conditioned or combination of conditioned liquid streams with one or more enhancements.

One or more of these and/or other objects, features or advantages of the present invention will become apparent from the specification and claims that follow.

According to one aspect of the present invention, a refrigerator is disclosed and includes a cabinet body and a dispenser associated with the cabinet body. The dispenser has at least one output comprising a variety of individually conditioned liquid streams. The refrigerator also includes a liquid conditioning circuit connected to the dispenser; the liquid conditioning circuit comprises a plurality of liquid conditioning components and each liquid conditioning component outputs an individually conditioned liquid stream for providing a variety of individually conditioned liquid streams at the dispenser. In a preferred form, at least one of the conditioned liquid streams comprises a combination of at least two individually conditioned liquid streams for providing varying levels and types of conditioned liquid streams at the dispenser, and one of the liquid conditioning components in the circuit comprise: (a) a liquid heating component outputting a heated liquid stream, (b) a liquid cooling component outputting a cooled liquid stream, (c) a liquid carbonating component outputting a carbonated liquid stream, and (d) a liquid filtering component outputting a filtered liquid stream.

According to another aspect of the present invention, a new method for dispensing a variety of individually conditioned liquid streams from a refrigerator dispenser is disclosed. The method includes the steps of introducing liquid into a liquid conditioning circuit of the refrigerator, distributing liquid to a plurality of separate liquid conditioning components in the liquid conditioning circuit, preparing a plurality of individually conditioned liquid streams with the liquid conditioning components, and providing an instruction to a valve in the circuit for outputting to the refrigerator dispenser an individually conditioned liquid stream or a combination of at least two individually conditioned liquid streams. The method also includes the steps of controlling mixing or separation of individually conditioned liquid streams and thereby type and level of conditioning of liquid output at the refrigerator dispenser by adjusting in the circuit at least one of a valve and/or a liquid conditioning component.

### BRIEF DESCRIPTION OF THE DRAWINGS

While the specifications concludes with claims particularly pointing out and distinctly claiming the invention, it is believed that the present invention will be better understood from the following description taken in conjunction with the accompanying drawings in which:

FIG. 1A is a front elevation view of a refrigerator illustrating a liquid conditioning system of a refrigerator according to an exemplary embodiment of the present invention;

FIG. 1B is a diagram for the liquid conditioning system illustrated in FIG. 1A;

FIG. 1C is another diagram illustrating a modulated liquid conditioning concept according to the exemplary embodiment of the present invention;

FIG. 2 is an illustration for a liquid conditioning system according to one circuit configuration of the present invention;

FIG. 3 is an illustration for a liquid conditioning system according to a parallel circuit configuration;

FIG. 4 is an illustration for a liquid conditioning system according to one circuit configuration of the present invention;

FIG. 5 is an illustration for a liquid conditioning system according to another circuit configuration;

FIG. 6 is an illustration for a modulated liquid conditioning system according to one possible configuration;

FIG. 7 is an illustration for a modulated liquid conditioning system and beverage preparation module according to an exemplary configuration of the present invention; and

FIG. 8 is another illustration for a modulated liquid conditioning system and beverage preparation module of the invention.

### DETAILED DESCRIPTION OF THE PREFERRED EMBODIMENTS

The present invention are directed to a refrigerator or other liquid dispensers having a liquid conditioning system having one or more liquid conditioning components or modules for providing an array of conditioned liquid streams and level of conditioning for dispensing from a refrigerator dispenser for drinking, or for use in preparing a beverage or food. The liquid conditioning components or modules provide sufficient flexibility to allow for operation one or all in combination and cooperation with a liquid enhancement system for preparing an enhanced beverage using any combination of the conditioned liquid streams.

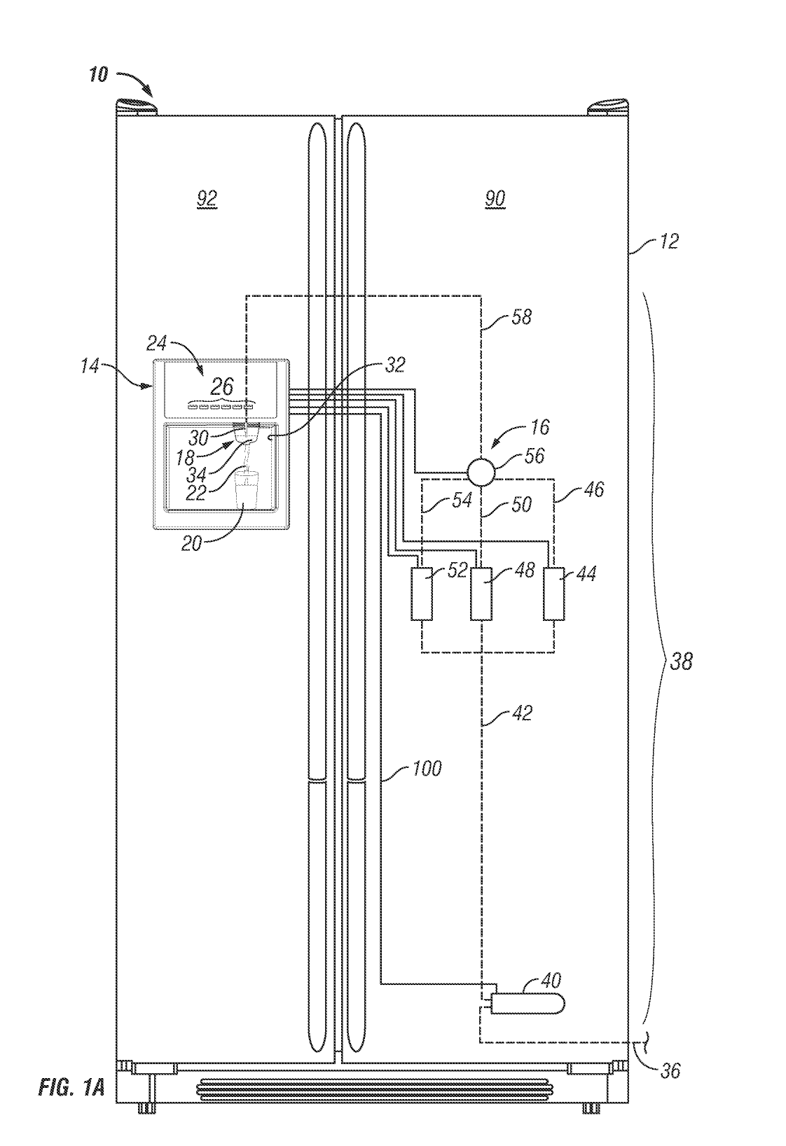

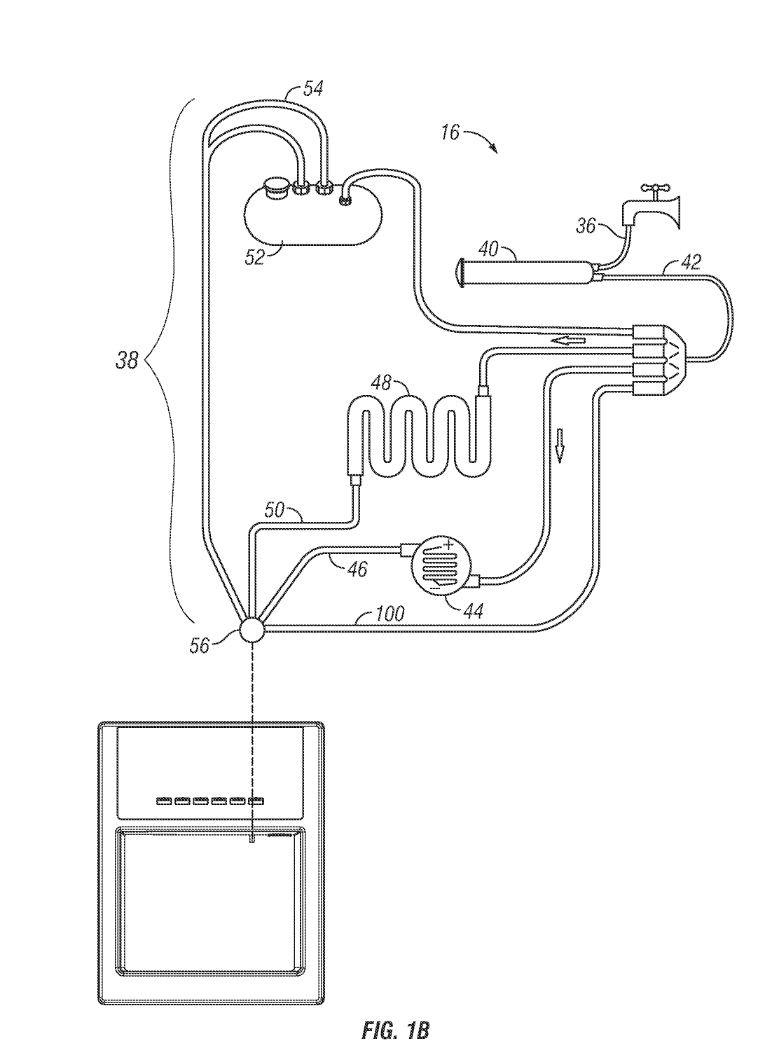

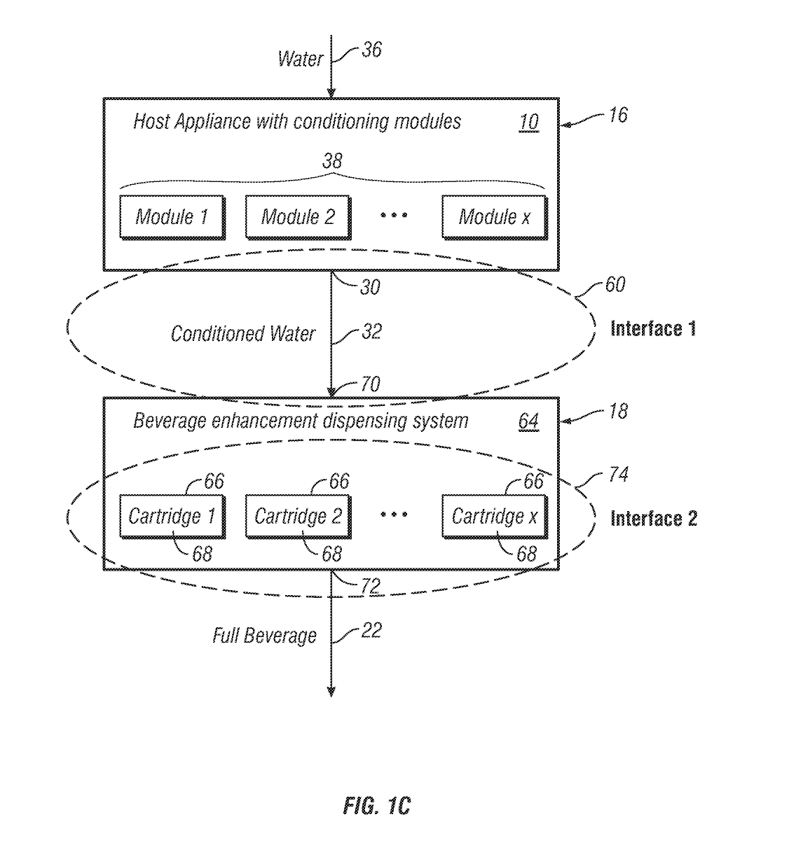

FIG. 1A illustrates a refrigerator 10 having a cabinet body 12 including a refrigerated compartment 90 and a freezer compartment 92 and an indoor dispenser 14 associate with cabinet body 12. The refrigerator 10 includes a liquid conditioning system 16. The liquid conditioning system 16 is connected to liquid stream inlet 36. Liquid from liquid source 22 may be stored in a liquid holding reservoir (not shown), before or after being filtered through an inline filter, and communicated to the beverage dispensing system 32 at the dispenser 20. Liquid from a plumbed water line enters into refrigerator 10 through liquid stream inlet 36 in fluid communication with liquid conditioning system 16. Those skilled in the art can appreciate and understand that liquid entering refrigerator 10 through liquid stream inlet 36 need not come from a plumber water line, but could come from a stored water source, such as a water bottle.

The liquid conditioning system 16, as illustrated in FIGS. 1A and 1B, includes a plurality of liquid conditioning components or modules 38. FIG. 1B illustrates several of the liquid conditioning components providing a general introduction, but not by way of limitation, to the liquid conditioning concepts of the present invention. In one aspect of the present invention, the plurality of the liquid conditioning components 38 could include a liquid filtering component 40, a liquid heating component 44, a liquid cooling component 48, and/or a liquid carbonated component 52. Those skilled in the art can appreciate that any one or more of the plurality of the liquid conditioning components 38 together with one, another, or all the conditioning components are contemplated, and as such are not limited to those illustrated in FIG. 1A-1B. For example, the present invention contemplates other conditioning components suitable for use in a liquid conditioning system 16 for refrigerator 10. Other liquid conditioning components/modules include, but are not limited to, a liquid oxygenating component whereby the liquid stream is conditioned or oxygenated as part of the liquid conditioning system 16. In another aspect, the liquid conditioning system 16 may include a liquid irradiating component whereby the liquid irradiating component may be configured to irradiate the liquid stream with UV lighting or any other lighting to condition the liquid stream. In yet another aspect, as best illustrated in FIG. 1B, a source of ambient temperature liquid, such as an ambient temperature module, may be included for providing ambient temperature liquid to the indoor dispenser 14 for use at liquid dispensing outlet 30. In all the above liquid conditioning considerations, the ability to modulate these liquid conditioning systems is also contemplated. Modulation of these systems could include the combination of one or more liquid conditioning systems into a single module. For example, a liquid cooling component and liquid carbonator could be included in a single module. Alternatively, a liquid heating component and ambient liquid temperature component could be configured into a single module.

In FIG. 1A liquid introduced into the refrigerator through liquid stream inlet 36 is communicated through liquid filtering component 40. A filtered liquid line communicates filtered liquid from filtered liquid component 40 into one or more of the plurality of remaining liquid conditioning components 38. It is to be understood that filtering represents one level of conditioning, and subsequent conditioning represents additional levels of conditioning. Within this logic, it is possible to prepare a finished liquid having passed through or received multiple levels of conditioning. Liquid conditioning is further diversified by the configuration or arrangement of the conditioning components and the subsequent arrangement of conditioning steps a conditioned liquid stream undergoes before being dispensed. For example, the conditioned liquid line 42 could junction and be split between the remaining plurality of liquid conditioning components 38 associated with refrigerator 10 to provide filtered liquid (e.g., liquid conditioned at one level) to each of the conditioning components 38. FIG. 1A illustrates the filtered liquid line 42 in communication with liquid heating component 44, liquid cooling component 48, and liquid carbonating component 52 according to an exemplary embodiment of the present invention. In this aspect, heated liquid is fluidly communicated from liquid heating component 44 through heated liquid line 46 upon actuation of valve 56, such as a mixing valve. Similarly, chilled liquid or cooled liquid is communicated from liquid cooling component 48 through cooled liquid line 50 upon actuation of valve 56. Filtered liquid communicated through filtered liquid line 42 into liquid carbonating component 52 is communicated through carbonated liquid line 54 upon actuation of valve 56. Those skilled in the art can appreciate that the order in which liquid stream inlet 36 is connected to one or more of plurality of liquid conditioning components 38 associated with the refrigerator 10 could be rearranged such that the liquid conditioning system 16 operates efficiently as possible. For example, liquid from liquid stream inlet 36 could be communicated through one or more of the plurality of liquid conditioning components 38 before the liquid filtering component 40. Alternatively, filtered liquid line 42 could communicate filter liquid directly to liquid dispensing outlet 30 of indoor dispenser 14. In another aspect of the invention, the output for the liquid filtering component 40 could be connected to inputs of each of the other liquid conditioning components (e.g., liquid heating, cooling and carbonating components) by a filtered liquid line whereby the filter outputs filtered liquid to all the conditioning components. Thus, in this instance a single liquid filtering component 40 is common or connected to all the conditioning components in the circuit. Those skilled in the art can also appreciate that valve 56 could be upstream or downstream of the plurality of the liquid conditioning components 38, or valve 56 could be configured at each liquid conditioning component and actuated by a control system associated with indoor dispenser 14. The present invention further contemplates that any one or all of the plurality of the liquid conditioning components 38 could be controlled and monitored electronically by being electrically or wirelessly connected to controls 26 associated with the user interface 24 of indoor dispenser 14. The specific hardware or components of each of the plurality of conditioning components 38 are not described herein. Those skilled in the art can appreciate the various and sundry types of liquid heating components 44, liquid cooling components 48, and liquid carbonating components 52 that are commercially available and suitable for use in heating, chilling and carbonating liquid. For example, an in-line heater, reservoir heater or batch system heater may be used to provide heated liquid. The refrigeration system, including a cold temperature environment within the refrigerator 90 or freezer compartment 92 may be used to provide cooled or chilled liquid. Commercial water chillers are also available for conditioning liquid to chilled liquid. The commercial carbonator system could include any number of commercially available components, such as a carbonator, water pump, pressure reducer, level controls and sensors, power supply, electrovalves, CO₂ tank and/or piping to provide a carbonated liquid. Each of these systems could be modulated or integrated into the liquid conditioning system 16.

FIG. 1A-B further illustrate a conditioned liquid line for communicating one or more of the plurality of conditioned liquid streams from the plurality of the liquid conditioning components 38 to liquid dispensing outlet 30 on indoor dispenser 14. The plurality of conditioned liquid streams can be communicated in a single conditioned liquid line 58 or multiple lines for communicating each conditioned liquid stream individually from the plurality of the liquid conditioning components 38 to a liquid dispensing outlet 30 of an indoor dispenser 14.

FIG. 1C illustrates another exemplary aspect of the present invention. According to the aforementioned concepts, liquid from liquid stream inlet 36 enters into the host appliance, such as a liquid dispenser or refrigerator 10. The host appliance includes a plurality of liquid conditioning components 38, such as module 1, module 2, etc. (see FIG. 1C). Those skilled in the art can appreciate that each module may be used to provide a conditioned liquid from liquid stream inlet 36. For example, module 1 may be used to provide a heated liquid stream, module 2 a carbonated liquid stream, and module X a chilled liquid stream. The host appliance is not limited to only those modules disclosed in FIG. 1C, but may include still other modules such as a module for providing ambient temperature liquid or an irradiating module which irradiates the liquid stream to provide irradiated liquid. Those skilled in the art can appreciate that one or more additional modules may be added to the host appliance, one module could be exchanged for another module, or multiple conditioning components combined into a single liquid conditioning module to bolster the capabilities of the liquid conditioning system 16. For example, the host appliance or refrigerator 10 may be configured to receive any number of liquid conditioning modules 38 to provide a plurality of conditioned liquid streams at liquid dispensing outlet 30. One or more of the conditioned liquid streams 32 are communicated to inlet 70 of liquid enhancement system 18. A liquid enhancement device interface 60 is provided and may include a cooperating attachment interfaces for securing the liquid enhancement system 18 about or to the liquid dispensing outlet 30 or liquid conditioning system 16 or circuit. The liquid enhancement system provides a means for enhancing a conditioned liquid stream. This includes adding or removing a beverage component from the conditioned liquid stream for providing a finished beverage. The liquid enhancement system could be configured as an integral component of the refrigerator or modulated to allow the addition or removal of the module from the refrigerator at any time. The liquid enhancement system 18 includes, but is not limited to, a liquid enhancement device 64. A plurality of container bodies 66 may be included within liquid enhancement device 64. Each container body 66 includes a liquid enhancement component 68. The liquid enhancement component 68 is used to enhance the conditioned liquid stream 32 from liquid dispensing outlet 30 and dispense from liquid enhancement system 18 out outlet 72 as an enhanced liquid stream 22 or a finished/completed beverage. Cooperating attachment interfaces 74 are provided for securing one or more of container bodies 66 within or to liquid enhancement system 18. Those skilled in the art can appreciate that one or more container bodies 66 housing liquid enhancement components 68 may be added to liquid enhancement system 18, removed from liquid enhancement system 18 or swapped out with another for providing the desired enhancement to the conditioned liquid stream dispensed from liquid dispensing outlet 30 of liquid dispensing system 16. For example, according to the embodiment illustrated in FIG. 1C, cartridge 1 may include one liquid enhancement component 68 and cartridge 2 another liquid enhancement component 68 whereby liquid enhancement system 18 controls the flow of conditioned liquid stream 32 through one or more of the cartridges to provide the desired enhanced liquid stream 22 at outlet 72 of liquid enhancement system 18.

According to another aspect of the present invention, liquid enhancement device 64 may be a single or multi-serve capsule, pouch or pod that is consumable, recyclable and commercially viable. Liquid enhancement device 64 includes one or more liquid enhancement components 68. Liquid enhancement components 68 may include, but are not limited to, a flavoring component, a soluble component, a non-soluble component, a powder, a liquid, a brew, a nutraceutical, a medicine, a mineral, a vitamin, an aroma, any combination of the aforementioned liquid enhancement components 68, or any combination of the aforementioned liquid enhancement components 68 where one liquid enhancement component 68 interacts or reacts with another or with the conditioned liquid stream 32 to provide an enhanced liquid stream 22. Use of the term “liquid enhancement device” should be construed to mean for the purposes of the present invention that the enhancement device enhances the liquid and not that the enhancement device is a liquid. The body of the liquid enhancement device or consumable may be configured as a container body, a pouch body, a capsule body, a pod body, a straw body, or any like shaped body suitable for storing and dispensing the aforementioned liquid enhancement components 68. The liquid enhancement device or consumable preferably contains a liquid enhancement component 68. The device or consumable may be configured to output a liquid enhancement stream, separate from streams originating from the host appliance (e.g., refrigerator), that may be joined, combined with or affect a conditioned liquid stream originating from a liquid conditioning component within the host appliance.

Conditioned liquid stream 32 dispensed from liquid dispensing outlet 30 is communicated by or through liquid enhancement device 64 to combine with or be affected by liquid enhancement component 68 dispensed through outlet 72 as enhanced liquid stream 22 to provide an enhanced beverage 20 or a finished drink.

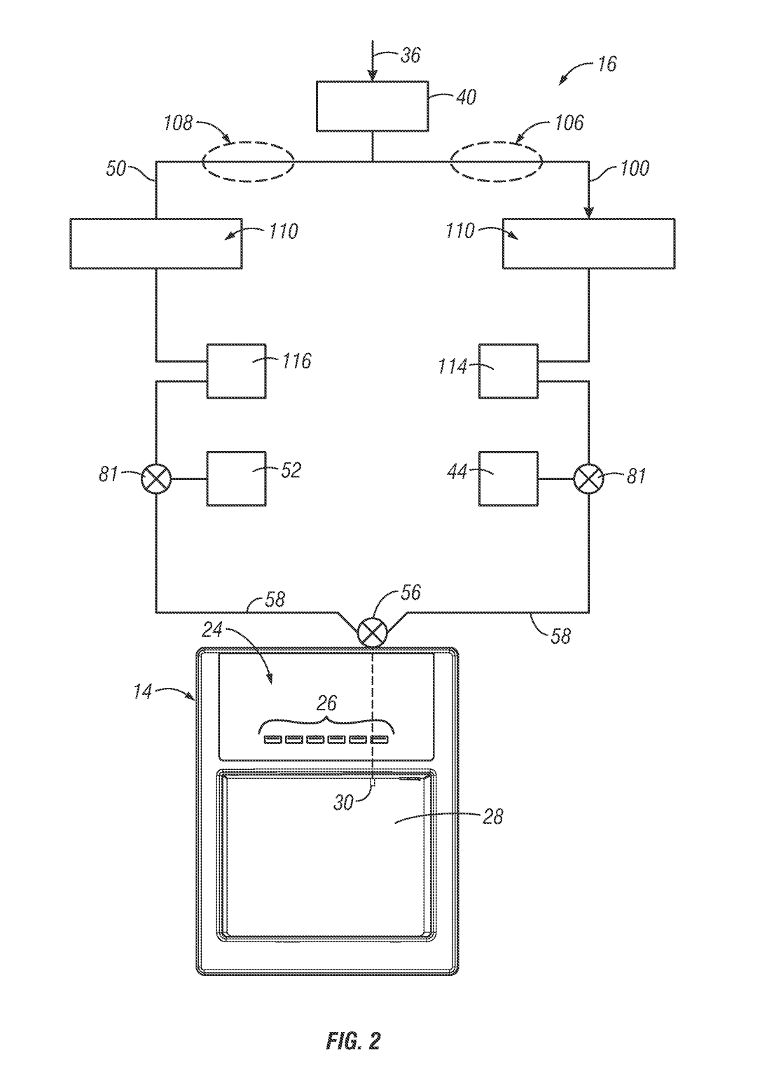

FIG. 2 is an illustration for a liquid conditioning system according to one circuit configuration of the present invention. The liquid conditioning system 16 illustrated in FIG. 2 provides a liquid conditioning circuit that enables an operator or user to create a variety of conditioned liquid streams. These conditioned liquid streams could be used within the refrigerator for other processes and/or dispensed via dispenser 14. Liquid is introduced into the liquid conditioning circuit via liquid stream inlet 36. The liquid stream inlet could be connected to a domestic water source or a bottled source. A liquid filtering component 40 is connected inline to liquid stream inlet 36. The filter provides conditioning to the liquid stream by filtering the liquid. This could be referred to as the first level of conditioning of the liquid stream. The circuit could also be configured so that the filter is bypassed. A valve could be placed before the filter to allow the circuit to operate in a bypass mode or in a flow through mode. Operation of the valve between the flow through and bypass mode could be controlled by instruction from the control panel or user interface 24 of dispenser 14. On one side (in this instance, the left leg) of the circuit a cold temperature reservoir 116 is connected to a pull back system 110 which is in turn connected to filter 40.

On the other side (the right leg) of the circuit an ambient temperature reservoir 114 is connected to a pull back system 110 which is in turn connected to filter 40. The temperature of the liquid from the source may be decreased or chilled by passing cooled liquid line 50 through a cold temperature environment 108. The cold temperature environment 108 could be located within the refrigerated or freezer compartment 90 and 92 of the refrigerator.

Other means for chilling liquid stream could include an inline water chiller, a reservoir chiller or batch chiller, or other commercially available water chilling components. The chilled water is maintained within cold temperature reservoir 116. Pull back system 110 connected to cold temperature reservoir 116 may be used to draw the body of cold temperature liquid back out of the reservoir for discarding in the case where the liquid remains in the reservoir for a period of time that might be undesirable. The pull back system 110 may also be used to evacuate the line connecting the pull back system with the cold temperature reservoir 116.

Similarly, liquid from liquid stream inlet 36 may be passed through an ambient temperature environment 106 via ambient temperature liquid line 100 for providing ambient temperature liquids to ambient temperature reservoir 114. A pull back system 110 is connected to the ambient temperature reservoir 114 and operates in conjunction with the ambient temperature reservoir 114 in a similar manner as described previously. The ambient temperature environment 106 may be a location within the refrigerator that remains in ambient temperature. This could include the passing of ambient temperature liquid line 100 through the ambient temperature environment for raising or lowering the temperature of the source liquid to the ambient temperature. The ambient temperature liquid is stored in the ambient temperature reservoir 114.

On the left side of the liquid conditioning circuit, the cold temperature reservoir 116 is in communication with valve 81 via a line connected to the reservoir and the valve. Also connected to valve 81 is a liquid carbonating component 52. The liquid carbonating component 52 uses the cold temperature liquid to produce a carbonated liquid stream. This carbonated liquid stream is communicated through conditioned liquid line 58 to control valve 56. Cold temperature liquid is carbonated and communicated onto control valve 56 or stored in a carbonated reservoir at the liquid carbonating component 52. Electronic instruction or actuation of valve 81 allows carbonated liquid to pass through conditioned liquid line 58 to control valve 56 upon instruction from the user interface 24 of dispenser 14.

The circuit shown in FIG. 2 could be configured to bypass the carbonator or whereby only a chilled liquid stream is communicated to the dispenser 14. Valve 81 could be configured to operate as a mixing valve to allow chilled liquid to combine with carbonated liquid depending upon the amount of carbonation or conditioning requested by a user or operator. Thus, the cold temperature liquid and carbonator can operate in combination with each other or separately to provide multiple levels of liquid conditioning and various types of conditioned liquid at the dispenser 14.

The liquid carbonating component 52 can be configured as previously discussed including all the necessary hardware and components for carbonating a liquid stream. Such liquid carbonating devices are commercially known and available, and could be used in an inline or reservoir configuration for carbonating a liquid stream.

On the right side of the circuit, ambient temperature liquid is communicated from reservoir 114 to valve 81 via a line connected to the reservoir and the valve. Valve 81 is also connected to a liquid heating component 44. Actuation of the valve allows an array of varying temperature liquid streams to be dispensed at the dispenser. The streams could include any liquid stream temperature ranging from the liquid temperatures output by the liquid heating component 44 and the ambient temperature reservoir 114. The liquid heating component 44 could be an inline batch or reservoir type heater. These types are commercially known and available.

Valve 81 is connected to control valve 56 via conditioned liquid line 58. Input from a user or operator at dispenser 14 provides instruction to valves 81 and control valve 56 for dispensing a desired conditioned liquid stream at dispenser 14. Thus, the liquid conditioning system 16 illustrated in FIG. 2 allows an operator/user to control various conditioning levels and types of conditioning for the liquid stream being dispensed from the dispenser.

The present invention contemplates that any one or all of the reservoirs or liquid conditioning components in the circuit illustrated in FIG. 2 could be in a modulated form or configuration whereby one or more may be easily swapped out and replaced with a different type of liquid conditioning component. For example, in the case where a liquid circuit that produces high volumes of chilled liquid is desired, one or more of the existing reservoirs or components could be swapped out for another cold temperature reservoir or liquid cooling component.

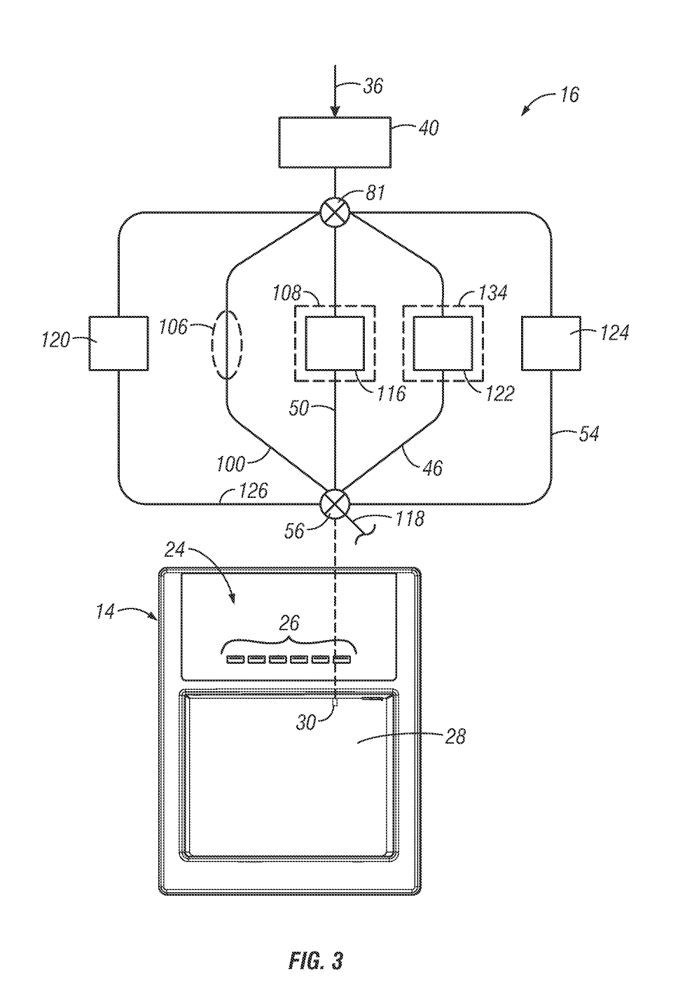

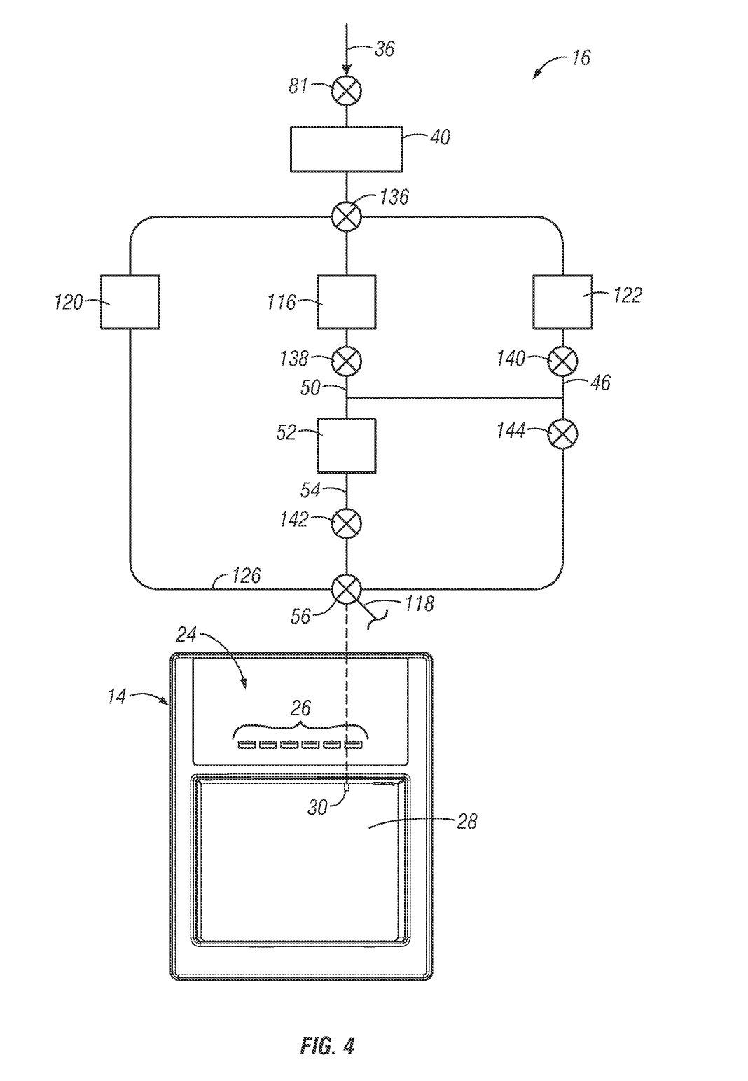

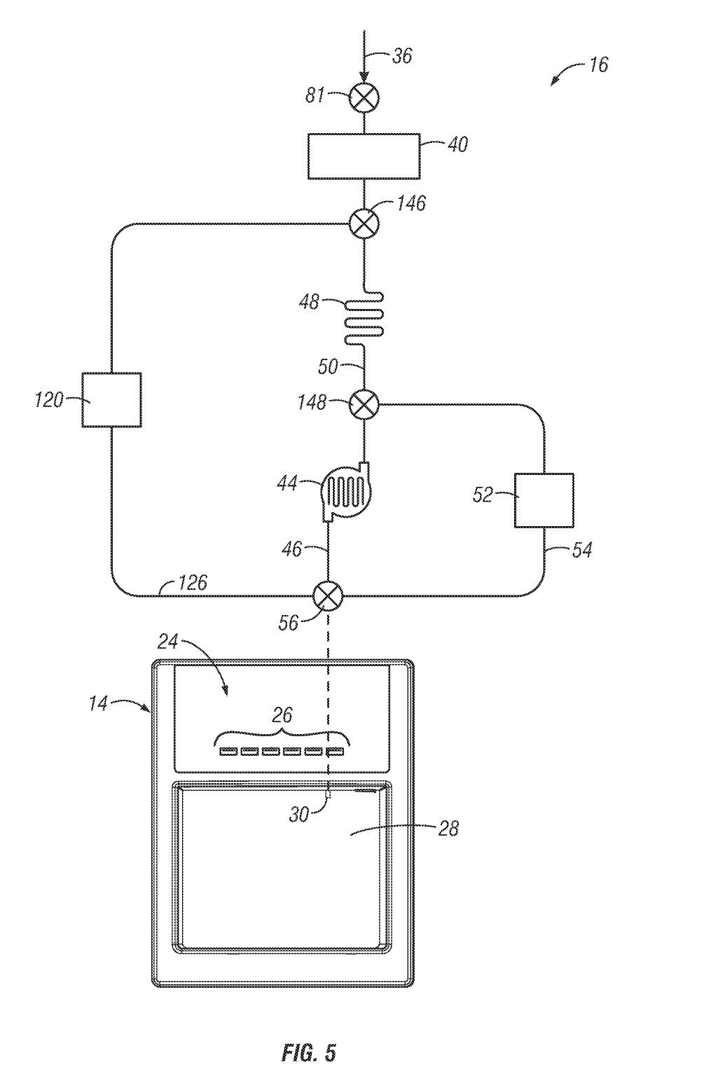

FIG. 3 is an illustration for a liquid conditioning system 16 according to a parallel circuit configuration of the present invention. Other circuit configurations are illustrated in FIGS. 4 and 5. The various circuit configurations of the invention may be configured as integral devices and components of the refrigerator or take on a more modulated form where such devices and components may be added to or taken away according to the various needs and wants of operators/users. The liquid conditioning circuit shown in FIG. 3 is one illustration of a parallel type configuration where components and devices are maintained in a parallel flow circuit. This type of circuit allows for multiple levels of liquid conditioning, as well as various types of liquid conditioning for providing a liquid stream to meet the conditioning needs of the user or operator, or the ultimate end use for such liquids.

The circuit configuration for the liquid conditioning system 16 illustrated in FIG. 3 receives liquid from a liquid stream inlet 36. The liquid stream inlet 36 is connected to a liquid filtering component 40 for filtering the liquid before it enters the parallel liquid conditioning circuit. The liquid filtering component 40 provides one level of liquid conditioning, and may in other liquid conditioning circuits be configured so that liquid stream inlet 36 bypasses liquid filtering component 40 thereby passing directly into the parallel liquid conditioning circuit.

Furthermore, based on the level of conditioning needed for subsequent or downstream liquid conditioning, a valve or bypass may be provided at the liquid filtering component 40 for either passing liquid through the filter or bypassing liquid around the filter to the parallel liquid conditioning circuit depending upon whether or not subsequent or downstream liquid conditioning processes require filtered or unfiltered liquid. For example, it may be appropriate to bypass the liquid filtering component 40 in the case where downstream conditioning or beverage preparation require the holding of liquid within a reservoir where chlorine or other preservation agents and ingredients are included in the domestic water stream to prevent growth of bacteria and other contaminants.

Other downstream liquid conditioning processes may require that the liquid be previously filtered. In such case, the valve or bypass may be instructed to pass the liquid stream through the liquid filtering component 40. The liquid filtering component 40 is connected with valve 81 so as to provide liquid communication between the two components. Hose, tubing and other liquid carrying membranes are contemplated. In a bypass configuration where water bypasses the filter 40, the valve 81 is in direct communication with liquid stream inlet 36. Valve 81 could be a four-way valve, such as an electronic solenoid controlled valve. Electronic operating instructions received from an operator or user's interactions with the user interface 24 of indoor dispenser 14 provide the necessary instructions to valve 81 so as to switch between open and closed positions with the various liquid conditioning components.

The present invention contemplates that valve 81 includes both open and closed positions where in these positions the valve is in communication with one, several or all of the liquid conditioning components at one time. According to one parallel liquid conditioning circuit of the invention, valve 81 is connected and in liquid communication with ice making component 120. The ice making component 120 provides another level of liquid conditioning. Filtered or unfiltered liquid passed through valve 81 into ice making component 120 converts the liquid into a solid phase. Various forms of the solid phase liquid may be provided such as crushed ice, cubes or other forms based on the conditioning needs of the system. Ice from the ice making component 120 is communicated to control valve 56 through guideway 126. The control valve 56 is configured to move ice to an outlet at the indoor dispenser 14 upon instruction from an operator or user using controls 26 of user interface 24. Depending upon the finished liquid conditioning requirements, the ice moved through guideway 126 into control valve 56 may be further conditioned before being dispensed through indoor dispenser 14. Furthermore, the ice from icemaker 126 may be used to further condition other liquid streams provided to the control valve 56 by other liquid conditioning components.

Configured in parallel with the icemaking component 120 is an ambient temperature liquid line 100. The ambient temperature liquid line 100 is in liquid communication with valve 81 and control valve 56. To decrease or raise the temperature of the liquid to ambient temperature, an ambient temperature environment 106 is provided through which the ambient temperature liquid line 100 passes through. The ambient temperature environment 106 could be an environment or place within a refrigerator that is not exposed to cooling or heating, that would otherwise remain at ambient temperature so that the liquid passing through valve 81 to control valve 56 is increased or decreased in temperature to the ambient temperature.

Configured in parallel with both the icemaker 120 and ambient temperature liquid line 100 is a cold temperature reservoir 116. The cold temperature reservoir 116 is connected to and in fluid communication with valve 81. Reservoir 116 is connected to and in fluid communication with control valve 56 via cooled liquid line 50. Either or both the line 50 and cold temperature reservoir 116 may be contained wholly or at least partially within a cold temperature environment 108 for chilling the liquid from valve 81 before passing through cooled liquid line 50 into the cold temperature reservoir 116. The chilling of liquid in the circuit provides another level of conditioning of the liquid stream.

Chilled liquid from the cold temperature reservoir 116, ambient temperature liquid from the ambient temperature liquid line 100 and ice from icemaker 120 may be used to provide further conditioning of any one of the aforementioned conditioned liquid streams. Other means for providing a chilled liquid stream are also contemplated in addition to passing cooled liquid line 50 and/or placing cold temperature reservoir 116 in a cold temperature environment 108. For example, an inline or batch liquid chiller may be used to provide chilled liquid at mixing valve 56. Other commercially available liquid cooling/chilling components are also contemplated for providing a chilled liquid stream to control valve 56 for outputting to the indoor dispenser 14 upon receiving instruction from an operator/user via control panel or user interface 24.

Like the cold temperature reservoir 116, a hot temperature reservoir 122 is configured in parallel with the cold water reservoir 116, ambient temperature liquid line 100 and icemaker 120. Upon actuation of valve 81, liquid is released through a line connected between valve 81 and hot temperature reservoir 122. Liquid within the hot temperature reservoir 122 may be heated by placing the line between the valve and the hot temperature liquid reservoir 122 or the reservoir itself within a hot temperature environment 134. This could be an environment within the refrigerator that continually provides a warm enough environment to provide a liquid of warm or hot temperature.

Other means for heating liquid for storing in hot temperature reservoir 122 are also contemplated. For example, an inline or batch water heater may be used to heat liquid stored within the reservoir. Other commercial water heaters whether inline or reservoir type may be used for heating liquid stored in reservoir 122. A heated liquid line 46 connects the hot temperature reservoir 122 with control valve 56. The hot temperature reservoir 122 provides another level of conditioning for preparing a diverse array of conditioned liquid streams for presenting at the dispenser 14. Also configured in the liquid conditioning circuit and parallel to the hot temperature reservoir 122, cold temperature reservoir 116, ambient temperature line 100 and icemaker 120 is a carbonated reservoir 124. The carbonated reservoir 124 is connected to valve 81 via water line. A carbonated liquid line 54 connects the carbonated reservoir 124 with control valve 56.

The carbonated reservoir 124 provides another level of conditioning in addition to the conditioning components previously discussed. The control valve 56 may be configured to be in communication with one or more dispensing outlets at dispenser 14 for providing a variety of conditioned liquid streams prepared by one or more of the conditioning components within the parallel circuit. Depending upon the desired conditioning level and type of the liquid stream requested at the dispenser, one or more of the conditioning components may work together to formulate the desired conditioned liquid meeting both conditioning level and conditioning type requirements input by the user or operator using user interface 24 of dispenser 14.

Control valve 56 may also be configured with a drain line 118 for draining off any one of the reservoirs or lines within the parallel liquid conditioning circuit. The drain line 118 could be tied into a commercial or residential drain system. The present invention contemplates that each of the liquid conditioning components in the parallel circuit may be integrated into an existing refrigerator or may be configured as a modulated component whereby one or more of the components may be swapped out for another type of liquid conditioning component depending upon the demands or needs of liquid conditioning requested by the operator or user. For example, in the case where the operator/user prefers to use the dispenser 14 for having a heated liquid, a second hot temperature reservoir could be added to the parallel liquid conditioning circuit or one of the existing modules could be swapped out for a hot temperature reservoir so as to increase the capacity of the parallel liquid conditioning circuit for providing heated liquid to the user or operator via dispenser 14.

FIG. 4 is an illustration for a liquid conditioning system 16 according to another circuit configuration of the invention. Like those previously discussed, the liquid conditioning circuit illustrated in FIG. 4 is connected to a liquid source such as a domestic water line or bottled source via liquid stream inlet 36. A valve 81 is connected at the inlet and may be electrically actuated by instruction from user interface 24 of dispenser 14. Valve 81 is connected to liquid filtering component 40. Liquid filtering component 40 is connected to valve 136 which is downstream from the filter. Valve 81 may be electronically actuated so as to allow liquid to pass through filter 40 or bypass filter 40 and be communicated directly to valve 136. Valve 136 is in fluid communication with filter 40 and downstream from the filter so as to control distribution of liquid through the circuit.

The liquid filtering component provides one level of conditioning of the liquid stream and may be used or bypassed depending upon the instructions received from a user or operator at the dispenser. It is also contemplated that valve 136 may be electronically actuated whereby the valve moves from one or more open positions to a closed position relative to the lines exiting the valve and extending to one or more of the liquid conditioning components in the circuit.

One leg of the circuit includes an ice making component 120 for providing liquid in the solid phase via guideway 126 to control valve 56. The ice making component 120 provides another level of liquid conditioning of liquid from the liquid source.

The middle leg of the circuit includes a cold temperature reservoir 116 in fluid communication with valve 136 via a line connected between the two. An inline water chiller, reservoir chiller or other commercially available liquid chiller may be used for chilling the liquid stored in the cold temperature reservoir 116. Additionally, the liquid line between valve 136 and reservoir 116 may be positioned within the refrigerator within a cold temperature environment so as to provide chilled liquid to the cold temperature reservoir 116.

On the downstream side and connected to cold temperature reservoir 116 is valve 138. Valve 138 is also connected to liquid carbonating component 52 via cooled liquid line 50. Electronic actuation or instruction of valve 138 provides communication of chilled liquid from the cold temperature reservoir 116 to liquid carbonating component 52.

Another valve 142 is provided on the downstream side of the liquid carbonating component 52; the two being connected via carbonated liquid line 54. As with previous valves, valve 142 may be electronically actuated or instructed via inputs or instructions received from a control panel or user interface 24 of dispenser 14. Valve 142 is in fluid communication with control valve 56 which is in turn in communication with dispenser 14. Through the middle leg of the liquid conditioning circuit, carbonated liquid may be provided at the dispenser 14.

The right leg of the liquid conditioning circuit includes a hot temperature reservoir 122 connected to valve 136. The temperature of the liquid may be raised from the source temperature by an inline, batch or reservoir type heater or other types of heaters that are commercially known and available. Additionally, the line extending from valve 136 to the reservoir 122 could extend or pass through environments of the refrigerator where such environments are subject to higher temperatures to provide a heated liquid stream to reservoir 122. Reservoir 122 holds a heated batch of liquid which is metered and communicated through heated liquid line 46 via valve 140. Valve 140 may be electrically operated and actuated by receiving instructions from dispenser 14.

Valve 144 downstream of valve 140 is in fluid communication with valve 140 and reservoir 122. Through the far right leg of the liquid conditioning circuit, heated liquid may be communicated to the dispenser 14. The cold temperature and hot temperature lines are connected via a line downstream of valves 138 and 140 respectively. Thus, cold temperature liquid from the middle leg of the circuit may be communicated to the dispenser through the downstream leg of the right circuit for providing cold temperature liquid at dispenser 14. This is accomplished as valves 140 and 142 remain closed while valve 144 remains open. Both valves 138 and 140 may be opened at the same time and at varying degrees to control the temperature of liquid, ranging between cold liquid temperature and the heated liquid temperature in reservoirs 116 and 122 respectively. This is accomplished by closing valve 142 and opening valve 144 while metering the opening of valves 138 and 140 to obtain the desired liquid temperature.

A drain line is connected to control valve 56 to allow the system to drain off any one of the conditioning components within the circuit. The control valve 56 is electronically controlled and actuated so that any one of the legs of the circuit may be opened at any time or all of the legs of the circuit to allow the system to drain through drain line 118. The drain line 118 may be connected to the sewer within a residential or commercial environment.

Thus, depending upon the request of the operator/user of dispenser 14, the liquid conditioning system 16 illustrated in FIG. 4 may be operated in such a manner to provide a liquid stream of various conditioning levels and types suitable to the various needs and wants of the operator or user.

As with previous embodiments, any one or all of the liquid conditioning components could be configured in a modulated form whereby one or more of the liquid conditioning components could be swapped out for another type of component. The liquid conditioning system 16 of the present invention would allow for subsequent liquid conditional component add-ons to the circuit. For example, a heated refrigerator could be configured with a liquid conditioning circuit that lacks a carbonating component. The circuit could include the necessary space, fittings and adaptations to allow for a carbonating component to be added to circuit at a later date to expand the types and level of liquid conditioning offered by the dispenser.

In the case where the circuit is configured with modulated liquid conditioning components, one or more of the modules could be swapped or replaced, or additional modules added where connections for such are already included in the circuit.

FIG. 5 is an illustration of a liquid conditioning system according to another circuit configuration. The liquid conditioning system 16 illustrated in FIG. 5 is connected to a liquid source via liquid stream inlet 36. The liquid source is separated from the system by valve 81. Valve 81 is in fluid communication with liquid filtering component 40. Valve 81 may be electronically actuated or initiated to move between a flow through configuration or a bypass configuration so as to pass liquid through filter 40 or around filter 40 into valve 146.

Valve 146 may also be electronically actuated via input or control from dispenser 14. Valve 146 is connected to ice making component 120. A guideway 126 is connected between icemaker 120 and control valve 56. The user interface 24 via controls 26 of dispenser 14 may be used to control operation of valve 146 and icemaker 120 as well as control valve 56.

Valve 146 is also connected to a middle leg of the circuit. The middle leg of the circuit includes a liquid cooling component 48 connected to valve 146 and valve 148. The liquid cooling component 48 may be an inline chiller or reservoir type chiller depending upon whether there is a need to store a batch of chilled water or provide chilled water in a more instantaneous manner. Liquid cooling component 48 is connected to valve 148 via cooled liquid line 50. Valve 148 is in turn connected with both the middle and right legs of the circuit. In the middle leg and downstream of valve 148 is a liquid heating component 44. Valve 148 receives instruction from a control panel user interface associated with dispenser 14 whereby liquid flow is diverted through the right or middle legs of the circuit depending upon the desired type and level of conditioning requested by the user or operator. The liquid heating component 44 could be an inline heater, batch heater, or a reservoir type heater. Other commercially known and available liquid heating components or devices may be used to provide heating/conditioning to the liquid stream. The liquid heating component 44 is in communication with control valve 56 via heated liquid line 46. The right leg of the circuit includes a liquid carbonating component 52 connected to valve 148 and control valve 56 via the carbonated liquid line 54. Thus, chilled liquid is passed from the liquid cooling component 48, valve 148 and carbonator 52 for outputting carbonated liquid. Control valve 56 may be configured with a drain line as with previous embodiments. Control valve 56 may be used to mix or combine individually conditioned liquid streams thereby providing further conditioning types and levels of conditioned liquid streams to the indoor dispenser 14. This could include the combination of one or more of the conditioned liquid streams from the left, middle or right legs of the circuit depending upon the desired level and type of conditioning requested by the operator or user of the dispenser 14. Each of the liquid conditioning components in the liquid conditioning system 16 could be modulated whereby one or more of the components could be replaced or swapped out in exchange for another same or different conditioning component. The modulation of the circuit allows the conditioning system to be highly flexible and robust in its ability to provide a varied degree of and type of finished (conditioned) liquid streams at dispenser 14.

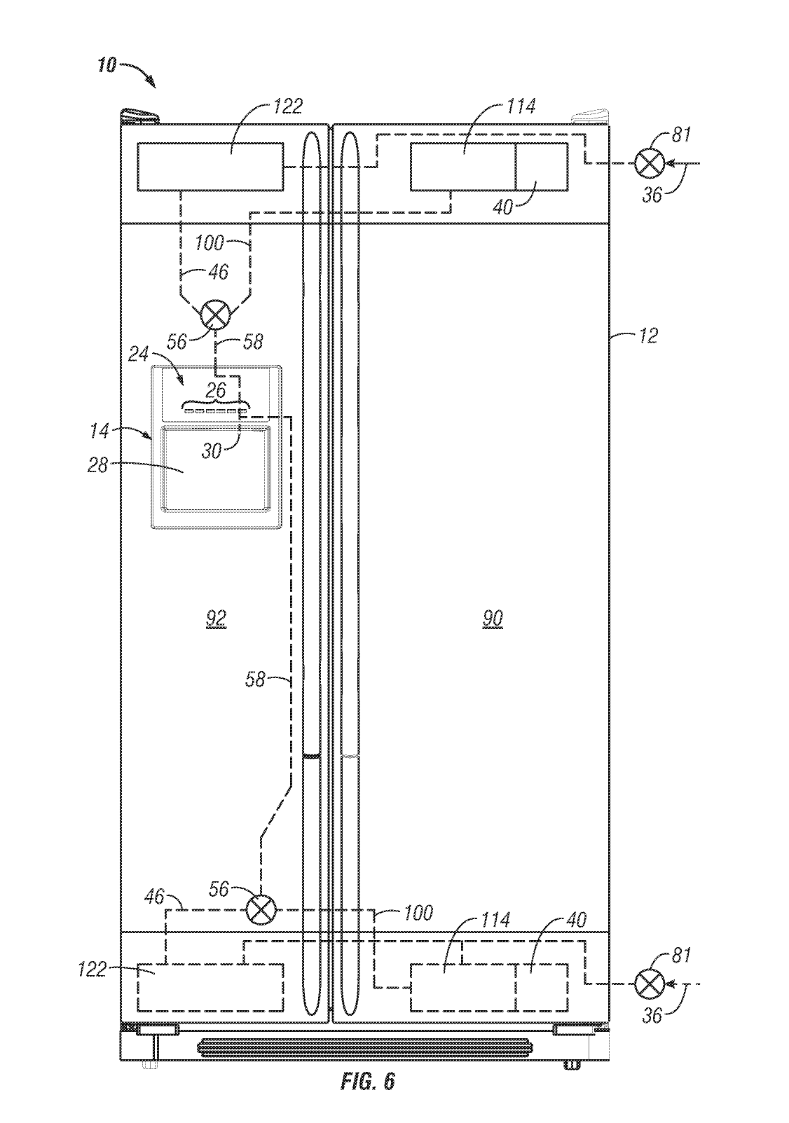

FIG. 6 is an illustration for a modulated liquid conditioning system according to one possible configuration of the present invention. As previously indicated, the present invention contemplates that the liquid conditioning circuits could be configured in a modulated format whereby one or more of the liquid conditioning components could be added, swapped out or exchanged for another different or same liquid conditioning component. The conditioning modules could be placed at the top or bottom of the refrigerator 10 within the cabinet body 12, or within one of the sides of the refrigerator 10 of the cabinet body 12. Modules could also be placed within the doors behind the door skin. The liquid conditioning modules could be placed so that an operator, user or owner of the refrigerator may be able to quickly access the module to troubleshoot or replace it with the same or different type of module.

Alternatively, the modules may be recessed or hidden behind various panels or skins of the refrigerator (whether structural or cosmetic) to prevent the modules from being bumped, dislodged or harmed.

FIG. 6 illustrates multiple embodiments for a modulated configuration. In one embodiment modules are provided at the top portion of the refrigerator 10, and in another embodiment these same or different modules are provided at a bottom portion of the refrigerator. The modulated liquid conditioning circuit illustrated in the top of refrigerator 10 includes a liquid stream inlet 36 connected to a water source such as a domestic water line. A valve 81 is connected inline with the liquid stream inlet 36 so as to control the flow of liquid through the circuit. The liquid conditioning modules are connected to valve 81. One of the modules includes an ambient temperature reservoir 114 and a liquid filtering component 40. The other module includes a hot temperature reservoir 122. The hot temperature reservoir 122 can include an inline or reservoir heating element to add heat to the liquid. Both modules are connected to control valve 56 via heated liquid line 46 and ambient temperature liquid line 100. The control valve 56 receives instructions from the user interface 24 of dispenser 14. Control valve is configured to meter liquid from the module so as to provide the desired level and type of conditioning of the liquid at the liquid dispensing outlet 30 of the dispenser. The control valve can provide heated liquid from the hot temperature reservoir 122 or ambient temperature liquid from the ambient temperature reservoir 114 to dispenser 14. A combination of the two conditioned liquid streams allows the dispenser to dispense liquid streams of varying temperature from the temperature of the liquid in the hot temperature reservoir 122 to the temperature of the liquid in the ambient temperature reservoir 114. Ambient temperature liquid stored in reservoir 114 may be filtered through liquid filtering component 40 before being communicated to control valve 56. Alternatively, liquid may be communicated from reservoir 114 to control valve 56 and remain unfiltered. The user/operator can place a cup or receptacle in the dispensing outlet area 28 underneath the liquid dispensing outlet 30 of dispenser 14 and put the operating parameters via controls 26 of the user interface 24 for controlling operation of the liquid conditioning system 16.

FIG. 6 also illustrates that the liquid conditioning components as previously discussed may be included in the bottom portion of refrigerator 10. These conditioning components may be alone or in addition to the conditioning components included in the top portion of refrigerator 10. For example, the conditioning circuit included in the bottom portion of the refrigerator may include a liquid carbonating component for providing a carbonated liquid stream to the dispenser 14.

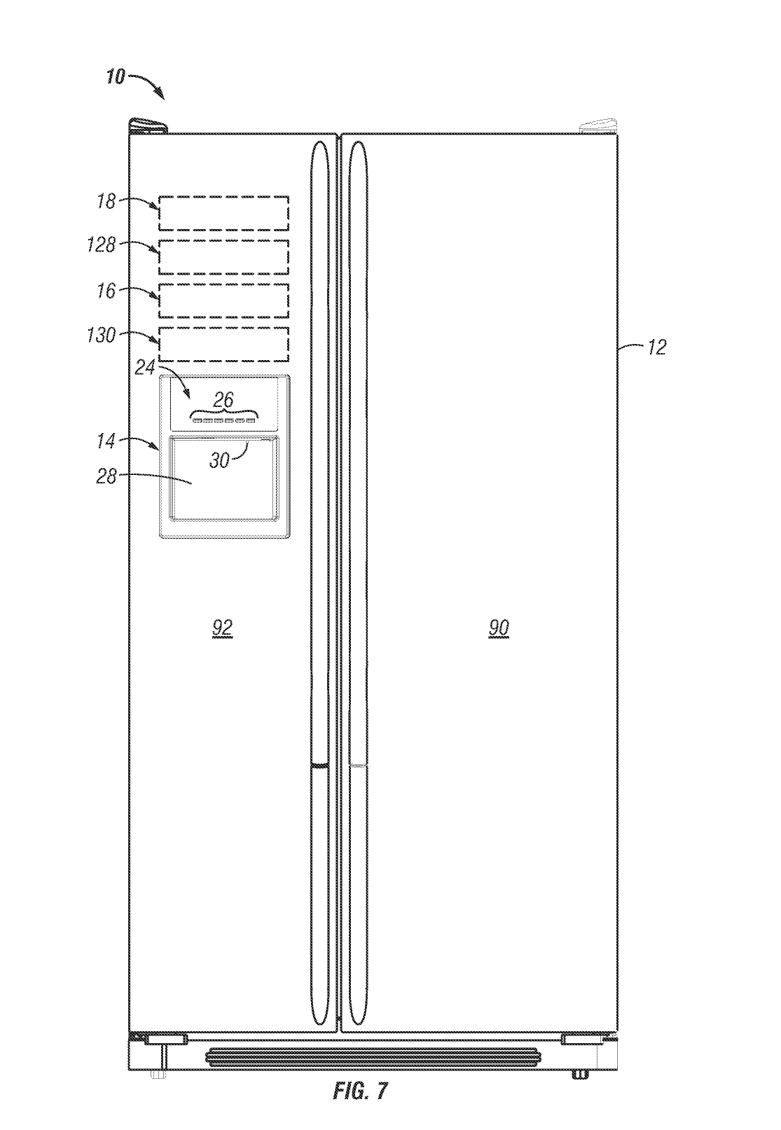

FIG. 7 provides an illustration for a modulated liquid conditioning system and beverage preparation module according to an exemplary configuration of the present invention. As discussed previously, the present invention contemplates the integration in combination of the liquid conditioning modules with other beverage preparation modules or systems.

FIG. 7 illustrates a refrigerator 10 having a cabinet body 12 and, in one embodiment, both refrigerated 90 and freezer 92 compartments. The refrigerator 10 also includes a dispenser 14. The dispenser 14 has a user interface 24 with controls 26 for controlling the type and level of condition of the outputs into the dispensing outlet area 28 via liquid dispensing outlet 30 and/or an ice dispensing outlet (not shown).

The refrigerator 10 includes a liquid conditioning to dispensing system interface 130. The interface 130 provides the necessary hardware, circuitry, components and devices for interfacing a liquid conditioning system 16 with the dispenser 14. The liquid conditioning system 16 could include any one of the aforementioned systems of the invention whether integrated into the refrigerator or configured in a modulated format.

Interface 130 could be configured to allow for liquid conditioning components or modules to be placed within the refrigerator at a location or position remote of the door or dispenser. For example, a carbonation or heating module may be positioned within the refrigerator at a location remote of the door dispenser whereby interface 130 allows communication of the conditioned liquid streams from these components to the dispenser 14. A liquid enhancement to liquid conditioning interface 128 is provided between the liquid conditioning system 16 and liquid enhancement system 18. The liquid enhancement system 18 as previous discussed includes one or more enhancement modules, cartridges, pouches, pods or other concentrate or enhancement carrying devices. The interface of these enhancement carrying devices is provided by the interfacing of these enhancement carrying devices with liquid conditioning system 16 is provided by interface 128. The liquid enhancement system 18 could be integrated within the refrigerator or configured as a modulated system whereby the system could be removed or added to the refrigerator at a later date. The order and arrangement of the liquid conditioning system 16 and liquid enhancement system 18 could be arranged to provide the requested beverage. For example, the liquid conditioning system 16 could condition a liquid stream using a carbonated liquid stream which is in turn interfaced with the liquid enhancement system via interface 128 whereby the carbonated liquid stream is combined with a concentrate. The flavored carbonated liquid stream provided by the liquid enhancement system is interfaced with the dispenser via interface 128. The user is able to select the type and level of conditioning whether provided by the liquid conditioning system or the liquid enhancement system for providing the desired beverage at the dispenser 14. Each of these systems may be configured in a modulated format so that one or more or all may be removed, replaced, exchanged or added at a later date.

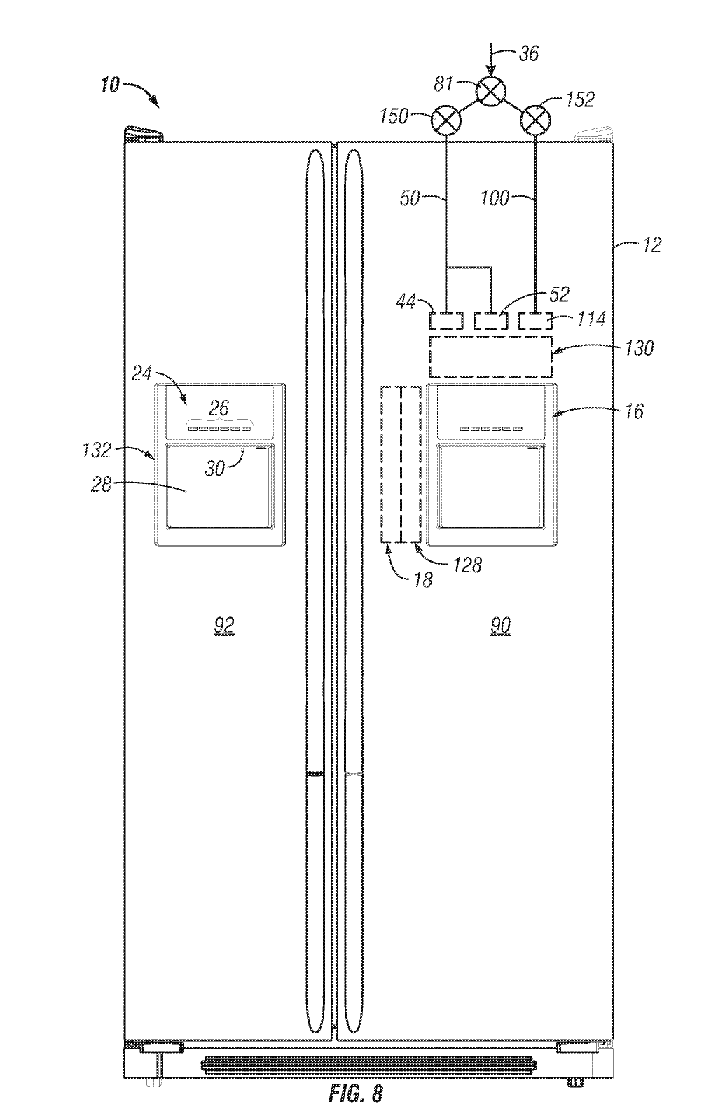

FIG. 8 is another illustration of a modulated liquid conditioning system used in combination with a beverage preparation module according to one aspect of the present invention. In FIG. 8 the refrigerator 10 includes a dispenser 132 having a liquid dispensing outlet 30 that dispenses into a dispensing outlet area 28. The dispenser 132 is controlled by receiving inputs to controls 26 at the user interface 24. Dispenser 132 provides the user with the basic water conditioning outputs of cold water and ice. Dispenser 132 may be configured into door of refrigerated compartment 90 or freezer compartment 92. On the opposing door or located at another position on the refrigerator 10 is a liquid conditioning system 16. The liquid conditioning system 16 provides a user or operator with a broad array of conditioned liquid streams. These conditioned liquid streams can also be enhanced for providing the user or operator with a beverage of his or her choice. The liquid conditioning system 16 is configured to receive a liquid stream from a liquid stream inlet 36. The liquid stream inlet 36 is connected to a valve 81 which in turn is connected to a left leg valve 150 and right leg valve 152. Valves 81, 159 and 152 may be electronically controlled by liquid conditioning system 16. Liquid from the inlet or from the source is communicated through the circuit from valves 150 and 152 through cooled liquid line 50 and ambient temperature liquid line 100. The liquid provided at the inlet may be chilled using any one of the aforementioned devices or techniques. Similarly, the liquid from the inlet may be changed in temperature to ambient temperature using any one of the aforementioned devices or techniques.

Chilled liquid is communicated via cooled liquid line 50 to liquid heating component 44 and/or liquid carbonating component 52. Ambient temperature liquid is communicated through line 100 to ambient temperature reservoir 114. These components allow the operator or user to dispense cold, hot, warm, or ambient temperature liquid from dispenser 16. Carbonated liquid may also be dispensed from liquid carbonating component 52.

In a modulated form, each conditioning component could be positioned at the same or different door of the refrigerator to allow for various conditioned liquid streams to be dispensed from a desired location or position on the appliance to provide an end user with maximum usability, flexibility and capability for dispensing conditioned liquid streams for drinking or preparing a beverage at the appliance.

A liquid conditioning to dispensing system interface 130 is provided between the liquid conditioning components and liquid conditioning system 16. Interface 130 provides the necessary hardware, connections, adaptors and other components for configuring the liquid conditioning components to interface with the liquid conditioning system 16. Positioned at the side of the dispenser is a liquid enhancement system 18. The liquid enhancement system 18 is interfaced with the dispenser by liquid enhancement to liquid conditioning interface 128. The liquid enhancement system 18 provides enhancement of the conditioned liquid stream provided by the liquid conditioning system 16. Thus, for example, the liquid conditioning system 16 may be used to prepare a carbonated liquid stream and the enhancement system 18 may be used to add a flavor enhancement to the carbonated liquid stream for providing a beverage at the dispenser.

The present invention contemplates that each of these systems may include modules such as the conditioning and enhancements components previously discussed which may be removed, replaced, exchanged, or added at a later date to the refrigerator 10.

The preferred embodiments of the present invention have been set forth in the drawings and in the specification and although specific terms are employed, these are used in the generically descriptive sense only and are not used for the purpose of limitation. Changes in the formed proportion of parts as well in the substitution of equivalents are contemplated as circumstances may suggest or are rendered expedient without departing from the spirit or scope of the invention as further defined in the following claims.

What is claimed is:

1. A refrigerator comprising:
a cabinet body;
a dispenser associated with the cabinet body, the dispenser having at least one output comprising a variety of individually conditioned liquid streams;
a liquid conditioning circuit connected to the dispenser, the liquid conditioning circuit comprising a plurality of liquid conditioning components; and
each liquid conditioning component outputting an individually conditioned liquid stream for providing the variety of individually conditioned liquid streams at the dispenser.

2. The refrigerator of claim 1 wherein at least one conditioned liquid stream comprises a combination of at least two individually conditioned liquid streams for providing varying levels and types of conditioned liquid streams at the dispenser.

3. The refrigerator of claim 2 wherein the liquid conditioning circuit further comprises a reservoir for temporarily storing the combined individually conditioned liquid streams for outputting at the dispenser.

4. The refrigerator of claim 1 wherein the liquid conditioning circuit further comprises a reservoir for temporarily storing one of the conditioned liquid streams for outputting at the dispenser.

5. The refrigerator of claim 1 wherein one of the liquid conditioning components in the circuit comprise:
a. a liquid heating component outputting a heated liquid stream; and
b. a liquid cooling component outputting a cooled liquid stream.

6. The refrigerator of claim 5 wherein the liquid conditioning components further comprise a liquid carbonating component outputting a carbonated liquid stream.

7. The refrigerator of claim 6 wherein the liquid conditioning components further comprise a liquid filtering component outputting a filtered liquid stream.

8. The refrigerator of claim 7 wherein the liquid filtering component is connected in communication with each liquid conditioning component in the liquid conditioning circuit whereby each component receives a filtered liquid stream from the liquid filtering component.

9. The refrigerator of claim 1 wherein one of the liquid conditioning components in the circuit comprise:
a. a liquid heating component outputting a heated liquid stream;
b. a liquid cooling component outputting a cooled liquid stream;
c. a liquid carbonating component outputting a carbonated liquid stream; and
d. a liquid filtering component outputting a filtered liquid stream.

10. The refrigerator of claim 1 wherein the liquid conditioning circuit further comprises a mixing valve having inputs for at least two individually conditioned liquid streams, the mixing valve having outputs comprising:
a. an individually conditioned liquid stream;
b. a combination of at least two individually conditioned liquid streams.

11. The refrigerator of claim 1 further comprising a liquid enhancement system in combination with the liquid conditioning circuit for outputting at the dispenser a finished beverage comprising the combination of:
a. a conditioned liquid stream; and
b. a liquid enhancement component.

12. The refrigerator of claim 11 wherein the liquid enhancement component comprises:
a. a flavoring component;
b. a soluble component;
c. a non-soluble component;
d. a powder;
e. a liquid;
f. a brew;
g. a nutraceutical;
h. a medicine;
i. a mineral;
j. a vitamin;
k. an aroma;
l. any combination of a-k; or
m. any combination of a-k where one liquid enhancement component interacts or reacts with another or with a conditioned liquid stream.

13. The refrigerator of claim 11 wherein the liquid enhancement component is contained within a consumable, the consumable adapted to output a liquid enhancement stream for combining with or affecting a conditioned liquid stream from a liquid conditioning component.

14. The refrigerator of claim 1 wherein each liquid conditioning component comprises a modulated component, whereby the liquid conditioning circuit is modified or reconfigured by adding, removing or exchanging a liquid conditioning module.

15. The refrigerator of claim 1 further comprising a user interface having a plurality of controls outputting an operating instruction to the liquid conditioning circuit to control conditioning and dispensing of the individually conditioned liquid streams at the dispenser.

16. A liquid conditioning circuit for use in combination with a refrigerator, the liquid conditioning circuit comprising:
a liquid input adapted for connection to a domestic or bottled source;
a plurality of liquid conditioning components connected to the liquid input, each component contributing to the liquid conditioning circuit an individually conditioned liquid stream; and
a valve having inputs for at least two individually conditioned liquid streams, the valve having outputs comprising at least one of:
a. an individually conditioned liquid stream;
b. a combination of at least two individually conditioned liquid streams.

17. The liquid conditioning circuit of claim 16 wherein one of the liquid conditioning components in the circuit comprise:
a. a liquid heating component outputting a heated liquid stream;
b. a liquid cooling component outputting a cooled liquid stream;
c. a liquid carbonating component outputting a carbonated liquid stream; and
d. a liquid filtering component outputting a filtered liquid stream.

18. The liquid conditioning circuit of claim 16 wherein the liquid heating, cooling and carbonating components each have an input connected to an output of the liquid filtering component for receiving the filtered liquid stream.

19. The liquid conditioning circuit of claim 16 in combination with a refrigerator and connected to a dispenser associated with the refrigerator for outputting a variety individually conditioned liquid streams at the dispenser.

20. The liquid conditioning circuit of claim 16 wherein each liquid conditioning component comprises a modulated component, whereby the liquid conditioning circuit is modified or reconfigured by adding, removing or exchanging a liquid conditioning module.

21. The liquid conditioning circuit of claim 16 in combination with a liquid enhancement system, the circuit having an interface connected to the liquid enhancement system for outputting a finished beverage comprising the combination of:
a. a conditioned liquid stream; and
b. a liquid enhancement component.

22. A method of dispensing a variety of individually conditioned liquid streams from a refrigerator dispenser, the method comprising:
introducing liquid into a liquid conditioning circuit of the refrigerator;
distributing liquid to a plurality of separate liquid conditioning components in the liquid conditioning circuit;
preparing a plurality of individually conditioned liquid streams with the liquid conditioning components;
providing an instruction to a valve in the circuit for outputting to the refrigerator dispenser:
a. an individually conditioned liquid stream; or
b. a combination of at least two individually conditioned liquid streams; and
controlling mixing or separation of individually conditioned liquid streams and thereby type and level of conditioning of liquid output at the refrigerator dispenser by adjusting in the circuit at least one of:
a. a valve;
b. a liquid conditioning component.

23. The method of claim 22 wherein the step of preparing a plurality of individually conditioned liquid streams comprises:
a. preparing a heated liquid stream;
b. preparing a cooled liquid stream;
c. preparing a carbonated liquid stream; and
d. preparing a filtered liquid stream.

24. The method of claim 23 further comprising the step of dispensing separately or mixing one or more of the heated, cooled, carbonated, or filtered liquid streams in the circuit for providing varying types and conditioning of a conditioned liquid output at the refrigerator dispenser.

25. The method of claim 22 wherein the liquid conditioning component comprises a modulated conditioning component.

26. The method of claim 25 further comprising the step of modifying or reconfiguring the liquid conditioning circuit by adding, removing or exchanging a liquid conditioning module.

27. The method of claim 22 in combination with a liquid enhancement system.

28. The method of claim 27 further comprising the step of both conditioning and enhancing liquid for outputting a finished beverage at the refrigerator dispenser.

29. The method of claim 27 further comprising the step of combining a liquid enhancement component with an individually conditioned liquid stream or a combination of individually conditioned liquid streams for a finished beverage at the refrigerator dispenser.
